(19) United States
(12) Patent Application Publication
(10) Pub. No.: US 2003/0227435 A1
(43) Pub. Date: Dec. 11, 2003

(54) Method for adjusting and detecting brightness of liquid crystal displays

(76) Inventor: Chang-Fa Hsieh, Banchiau City (TW)

Correspondence Address: SNELL & WILMER, ONE ARIZONA CENTER, 400 EAST VAN BUREN, PHOENIX, AZ, 850040001

(21) Appl. No.: 10/445,429

(22) Filed: May 27, 2003

(30) Foreign Application Priority Data
Jun. 6, 2002 (TW) 091112193

(51) Int. Cl. G09G 3/36

(52) U.S. Cl. 345/102

(57) ABSTRACT

The present invention provides a method for adjusting and detecting the brightness of a backlight of a liquid crystal display. The adjusting method includes setting a predetermined value having the brightness information, detecting the brightness of the backlight and getting a detected value which is an analog signal, transferring the analog signal to a digital signal, comparing the digital signal with the predetermined value. Then, if the digital signal is not equal to the predetermined value, then the microprocessor determines an adjusting value. According to the adjusting value, the microprocessor adjusts the brightness of the backlight.

### CROSS REFERENCE TO RELATED APPLICATIONS

This Application claims priority to Taiwan Patent Application No. 091112193 entitled “METHOD FOR ADJUSTING AND DETECTING BRIGHTNESS OF LIQUID CRYSTAL DISPLAYS”, filed Jun. 6, 2002.

### FIELD OF INVENTION

This present invention relates to a liquid crystal display, and more particularly, to a liquid crystal display allowing detection and adjustment of brightness.

### BACKGROUND OF THE INVENTION

In general, the liquid crystal display includes a backlight module behind the display panel for generating backlight illuminating the display panel from behind. The light passes through the pixels of display panel selectively to produce the visible images on the display panel. The liquid crystal display of this type has high CONTRAST allowing the users to perceive the displayed images even in the dark environment.

Typically, the sources generating backlight, e.g. cold cathode fluorescent tube (CCFL), LED, EL, have features of high BRIGHTNESS and use-perseverance. With respect to the locations of backlight modules, the backlight module may be classified into straight-below and side-edge types.

In earlier ages, the liquid crystal displays were applied in digital products, e.g. calculators and watches. In recent years, the sizes of the liquid crystal display grows bigger allowing their applications in areas of desk-top monitors and notebook computers.

It is found that bulbs for generating the backlight age and the brightness of bulb deteriorates as times go by. Since the deterioration of brightness might not be noticed by the users, the visual capabilities of the users may have been damaged for a period of time before the damage comes above the surface. Therefore, it is desirable to have a method for notifying the users as the brightness of backlight lowers and for making suitable adjustment.

### SUMMARY OF THE INVENTION

One aspect of the present invention provides a method for adjusting brightness of backlight of the liquid crystal display.

Another aspect of the present invention provides a method for detecting brightness of backlight of the liquid crystal display.

In the present invention, the liquid crystal display includes the backlight, the luminance sensor, the A/D converter, the microprocessor and the memory. The adjustment method includes setting a target brightness value; detecting brightness of the backlight via the luminance sensor and denoting as X; the A/D converter converting signal of X into signal of Y; the microprocessor comparing signal of Y with the target brightness value and generating a corresponding result; if signal of Y is not equal to the target brightness value, the microprocessor determining an adjustment value; and adjusting brightness of the backlight based on the adjustment value.

The detection method includes adjusting the backlight to a maximum brightness; detecting maximum brightness of the backlight and denoting as analog signal of X; converting the analog signal of X into a digital signal of Y; comparing digital signal of Y with the predetermined value and outputting a corresponding signal.

### BRIEF DESCRIPTION OF THE DRAWINGS

FIG. 1 is a functional block of the preferred embodiment;

FIG. 2 is a flow chart of the first embodiment; and

FIG. 3 is a flow chart of the second embodiment.

### DETAILED DESCRIPTION

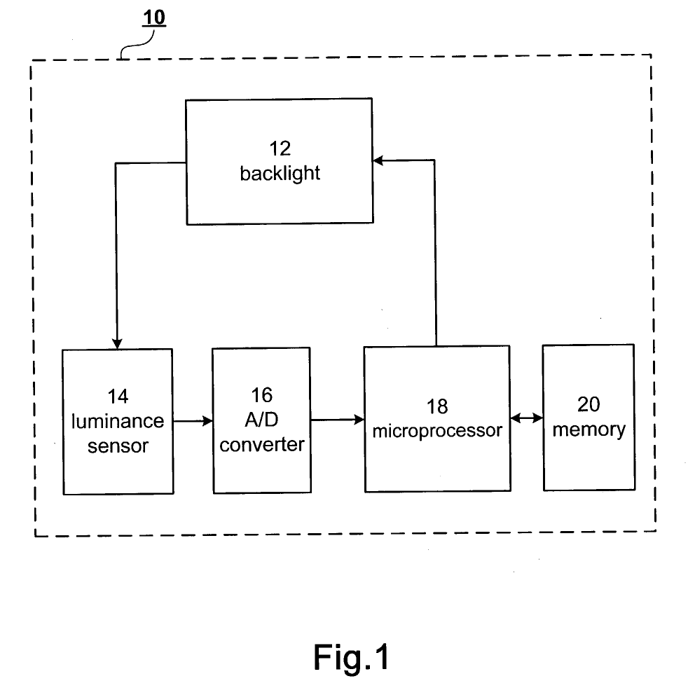

As shown in FIG. 1, according to the present invention, the liquid crystal display 10 includes a backlight 12, a luminance sensor 14, an A/D converter 16, a microprocessor 18 and a memory 20. The luminance sensor 14 is configured to detect the brightness of backlight 12. The A/D converter 16 is configured to transform the analog signal into digital signal. The microprocessor 18 is configured to compare the result of detection and a target brightness value and send commands to control the brightness of backlight 12. The memory 20 is configured to store predetermined values that include the target brightness value.

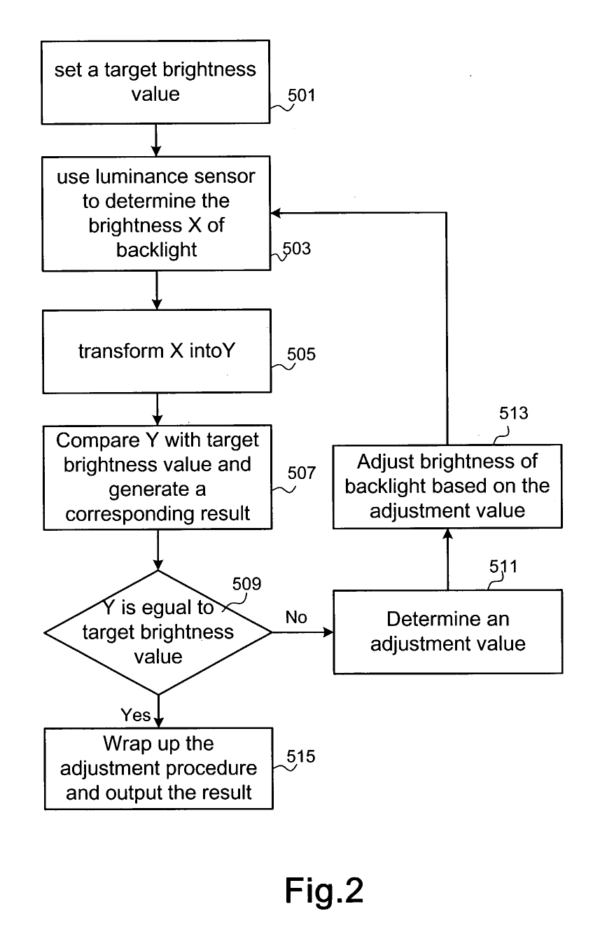

As shown in FIG. 2, the first embodiment may be employed to adjust the brightness of liquid crystal display. In step 501, the embodiment first sets a target brightness value and stores this value into the memory 20. In succession, in step 503, the embodiment turns on the backlight 12, uses the luminance sensor 14 to determine the brightness of backlight 12, and denotes the brightness as X which is an analog signal. In step 505, the signal X is transformed into digital signal Y by the A/D converter 16.

In step 507, the microprocessor 18 compares Y with the target brightness value and generates a corresponding result. In step 509, the microprocessor 18 determines if Y is not equal to the target brightness value. If Y is not equal to the target brightness value, in step 511, the microprocessor 18 determines an adjustment value. In step 513, the microprocessor 18 adjusts brightness of the backlight 12 based on the adjustment value. Afterwards, repeat step 503, 505, 507 and 509.

In step 509, if Y is substantially equal to the target brightness value, then in step 515, wrap up the adjustment procedure and output the result. The result outputted may be in form of image type that includes graphics or text on a monitor. Or, alternatively, the result is presented in the form of an audio type or, alternatively, in the form of an audio and/or image type.

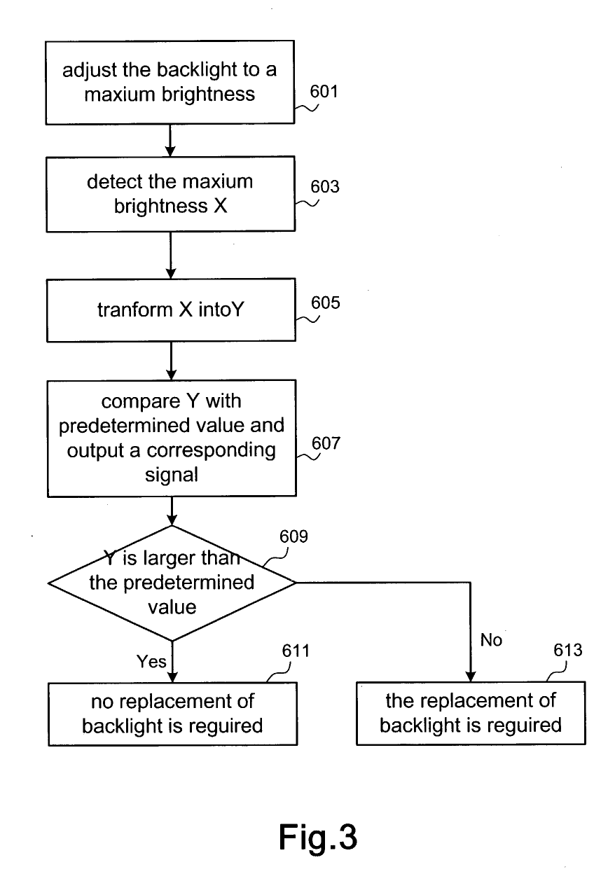

After the users use the liquid crystal display for a period of time, the embodiment as shown in FIG. 3 can be used to determine whether the replacement of backlight 12 is needed.

As shown in FIG. 3, responsive to user's instruction, in step 601, the microprocessor 18 sends a signal to adjust the backlight 12 to a maximum brightness. Afterwards, in step 603, the luminance sensor 14 detects the maximum brightness of the backlight and denotes it as analog signal of X. In step 605, by the A/D converter 16, the signal X is transformed into digital signal of Y. In step 607, the microprocessor 18 compares the digital signal of Y with the predetermined value and outputting a corresponding signal.

In step 611, the corresponding signal from the microprocessor 18 denotes that no replacement of the backlight 12 is required if Y is larger than or substantially equal to the predetermined value stored in memory 20 and wrap up the procedure. On the contrary, in step 613, the corresponding signal from the microprocessor 18 denotes that replacement of the backlight is required if Y is smaller than the predetermined value and wrap up the procedure.

And the corresponding signal may be in form of image type that includes graphics or text on a monitor. Or, alternatively, the result is presented in the form of an audio type or, alternatively, in the form of an audio and/or image type.

We claim:

1. A method for adjusting brightness of a backlight to a liquid crystal display, comprising the steps of:
setting a target brightness value;
detecting brightness of the backlight and denoting said brightness as X;
comparing X with the target brightness value and generating a corresponding result;
adjusting brightness of the backlight if X is not equal to the target brightness value; and
repeating the detecting, comparing and adjusting steps, until X is substantially equal to the target brightness value.

2. The method of claim 1, wherein the adjusting step comprises:
determining an adjustment value; and
adjusting brightness of the backlight based on the adjustment value.

3. The method of claim 1, wherein the corresponding result is presented in form of image type.

4. The method of claim 1, wherein the corresponding result is presented in form of audio type.

5. A method for adjusting brightness of a backlight to a liquid crystal display, the liquid crystal display comprising a luminance sensor, a microprocessor, and an A/D converter, the method comprising the steps of:
setting a target brightness value;
the luminance sensor detecting brightness of the backlight and denoting said brightness as an analog signal X;
converting the analog signal X into a digital signal Y with the A/D converter;
comparing the digital signal Y with the target brightness value and generating a corresponding result with the microprocessor;
if the digital signal Y is not equal to the target brightness value, determining an adjustment value with the microprocessor;
adjusting brightness of the backlight based on the adjustment value; and
repeating the detecting, converting, comparing, determining and adjusting steps, until the digital signal Y is substantially equal to the target brightness value.

6. The method of claim 5, wherein the corresponding result is presented in form of image type.

7. The method of claim 5, wherein the corresponding result is presented in form of audio type.

8. A method for detecting brightness of a backlight to a liquid crystal display having a memory for storing a predetermined value, the method comprising the steps of:
adjusting the backlight to a maximum brightness;
detecting maximum brightness of the backlight and denoting said maximum brightness as analog signal X;
converting the analog signal X into a digital signal Y; and
comparing digital signal Y with the predetermined value and outputting a corresponding signal.

9. The method of claim 8, in the comparing step, wherein
the corresponding signal denotes that no replacement of the backlight is required if Y is larger than or equal to the predetermined value; and
the corresponding signal denotes that replacement of the backlight is required if Y is smaller than the predetermined value.

10. The method of claim 8, wherein the corresponding signal is presented in form of image type.

11. The method of claim 8, wherein the corresponding signal is presented in form of audio type.

12. A method for adjusting brightness of a backlight to a liquid crystal display, the liquid crystal display comprising a luminance sensor, a microprocessor, an A/D converter, and a memory, the memory storing a brightness predetermined value, the method comprising the steps of:
adjusting the backlight to a maximum brightness;
detecting maximum brightness of the backlight and denoting said maximum brightness as an analog signal of X by the luminance sensor;
converting the analog signal of X into a digital signal of Y;
comparing digital signal of Y with the predetermined value; and
outputting a signal, wherein the signal denotes no replacement of the backlight is required if Y is greater than the predetermined value; and wherein the signal denotes replacement of the backlight is required if Y is smaller than the predetermined value.

13. The method of claim 12, wherein the signal in the outputting step is in form of an image type.

14. The method of claim 12, wherein the signal in the outputting step is in form of an audio type.
